(19) United States
(12) Patent Application Publication
(10) Pub. No.: US 2015/0161249 A1
(43) Pub. Date: Jun. 11, 2015

(54) FINDING PERSONAL MEANING IN UNSTRUCTURED USER DATA

(71) Applicant: LENOVO (SINGAPORE) PTD. LTD., Singapore (SG)

(72) Inventors: Jonathan Gaither Knox, Morrisville, NC (US); Rod D. Waltermann, Rougemont, NC (US); Hermann Franz Burgmeier, Chapel Hill, NC (US); Peter Hamilton Wetsel, Raleigh, NC (US); Suzanne Marion Beaumont, Wake Forest, NC (US); Russell Speight VanBlon, Raleigh, NC (US)

(73) Assignee: LENOVO (SINGAPORE) PTD. LTD., Singapore (SG)

(21) Appl. No.: 14/098,118

(22) Filed: Dec. 5, 2013

(51) Int. Cl. G06F 17/30

(52) U.S. Cl. CPC G06F 17/30705; G06F 17/30702

(57) ABSTRACT

An embodiment provides a method, including: collecting, using a user device, user object event data; collecting, using a user device, contextual data related to the user object event data; creating, using at least one processor, an association between the contextual data and the user object event data; forming, using a processor having access to a stored group of associations between contextual data and user object event data, a user profile based on the group of associations; and storing, in a memory, the user profile. Other aspects are described and claimed.

### BACKGROUND

Information handling devices (“devices”), for example laptop computers, tablets, smart phones, etc., may be used to sense or ascertain a large amount of unstructured data, e.g., global positioning satellite (GPS) coordinates, data regarding connected hardware devices, data regarding co-located user devices, audio data, etc. Additionally, devices may collect data regarding user objects, e.g., files, pictures, media content, etc., such as when these user objects are saved/stored, transmitted (sent, received), retrieved via a particular search input, etc.

Various device applications use part of the available data. For example, a navigation application may make use of the GPS coordinates by associating them with known locations available in map data. Other device application use different parts of the available data. For example, a network connection manager may use sensing data regarding nearby network devices to facilitate formation of a network connection therewith.

### BRIEF SUMMARY

In summary, one aspect provides a method, comprising: collecting, using a user device, user object event data; collecting, using a user device, contextual data related to the user object event data; creating, using at least one processor, an association between the contextual data and the user object event data; forming, using a processor having access to a stored group of associations between contextual data and user object event data, a user profile based on the group of associations; and storing, in a memory, the user profile.

Another aspect provides an information handling device, comprising: a processor; and a memory device that stores instructions executable by the processor to: collect user object event data; collect contextual data related to the user object event data; create an association between the contextual data and the user object event data; form, via access to a stored group of associations between contextual data and user object event data, a user profile based on the group of associations; and store, in a memory, the user profile.

Another aspect provides a product, comprising: a storage device having code stored therewith, the code comprising: code that collects, using a user device, user object event data; code that collects, using a user device, contextual data related to the user object event data; code that creates, using at least one processor, an association between the contextual data and the user object event data; code that forms, using a processor having access to a stored group of associations between contextual data and user object event data, a user profile based on the group of associations; and code that stores, in a memory, the user profile.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method of recording context and forming contextual data associations.

FIG. 4 illustrates an example method of using context for conducting searches.

FIG. 5 illustrates an example method of forming a user profile using contextual data associations.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Although a large amount of data may be sensed or ascertained by a device, only a small sub-set of this data is actually captured and stored. Moreover, even the data that is captured and stored is not typically structured or organized such that it may be put to maximum use for enhancing a user's experience when interacting with a device. For example, unstructured data such as raw GPS coordinates are random and un-useful if not stored, associated or correlated with other data, e.g., location data available in a map data store, and not maximally useful if not associated or correlated with other user data, e.g., user object event data such as file save, file transmission, file receipt, etc., user object event data.

For example, when searching for a file (e.g., picture, document, music file, etc.), a user tends to remember things based not only on the properties of the object itself, e.g., title, content, etc., but also based on the context associated with the object. Users tend to associate sensed information with object related events (e.g., object creation, storage, retrieval, editing, transmission, etc.). That is, users tend to remember what they were doing or what the environment was like when they were using/interacting with the object. As such, when users search for something, it is often through these alternative associations that users find what they are looking for.

Current search applications base their searching on the properties of the object, i.e., the search target. However, it happens that those object properties (e.g., file name, date/time when saved, etc.) are often not known to the users, not remembered by the users, or misstated by the users when inputting search terms. In these cases, searching becomes an inaccurate and/or tedious endeavor, that may not yield any relevant results.

Accordingly, an embodiment collects ephemeral data to provide context information that may be used, e.g., to augment searching. By recording as much information as possible that may be used to provide or infer the current context, rich and natural associations to user content (herein “user objects”) can be made. As will be further appreciated below, contextual data may be derived from a variety of sources, e.g., sensor inputs, hardware connection information, virtual connection information, device state information, etc. This collection of data can be described as real-time or ephemeral data, that is, data or information that is known in the moment, but cannot be discerned at a later time. For example, an embodiment utilizes ephemeral data obtained, e.g., via sensors collecting GPS coordinates, audio data, biometric data, device state data, etc., and makes this ephemeral data available to assist or augment application functionality, e.g., searching for user objects.

By recording the ephemeral data set in association with file, process, application and/or hardware connection events, it is possible to rewind and reconstruct a point in time to accurately represent the context associated with the object event, e.g., object creation, object access, etc. If this contextual information is married with forensic type information, like meta-data, keyword extraction, and so on, then the associations to a user's content are extremely rich and in fact support low and high order correlations useful in various applications. For example, a user could search for a file based not only on surmised keywords, but, using an embodiment, also based on where he or she was when a document was read or edited, or who the document was shared with during a meeting, or even the temperature of the room when he or she accessed the document, etc.

Additionally, given that contextual data associations may be formed using the data collected by a device, an embodiment may profile a user to infer the user's interests, preferences, tastes, etc. This information may be stored in a user profile that is accessible to various device applications and may be employed to enhance or augment the functionality of the device applications. A user's profile may include information collected about a single user across many devices and/or information regarding a group of like users.

The illustrated example embodiments will be best understood by reference to the figures. The following description is intended only by way of example, and simply illustrates certain example embodiments.

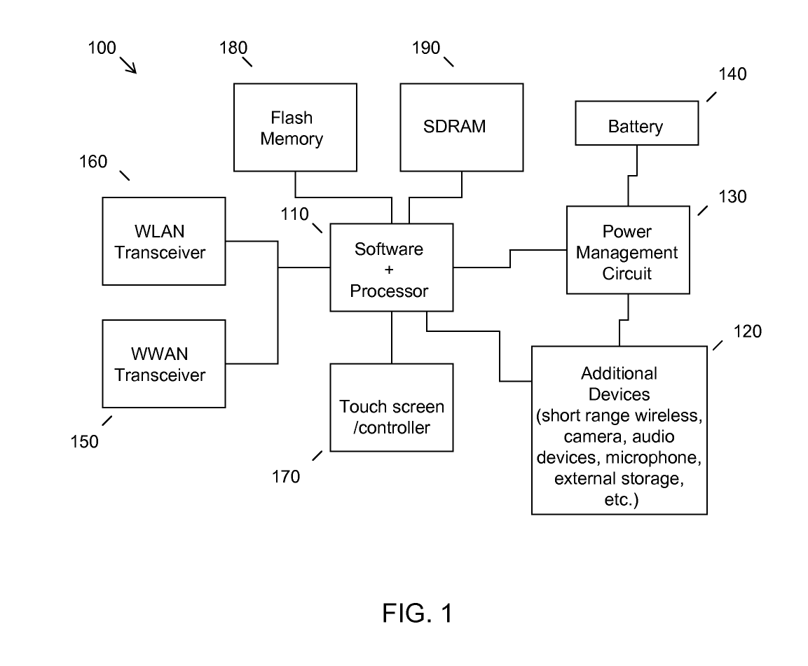

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a microphone, which may include physical elements that transforms sound waves into an electrical audio signal. Commonly, system 100 will include a touch screen 170 for data input and display/rendering. System 100 also typically includes various memory devices, for example flash memory 180 and SDRAM 190.

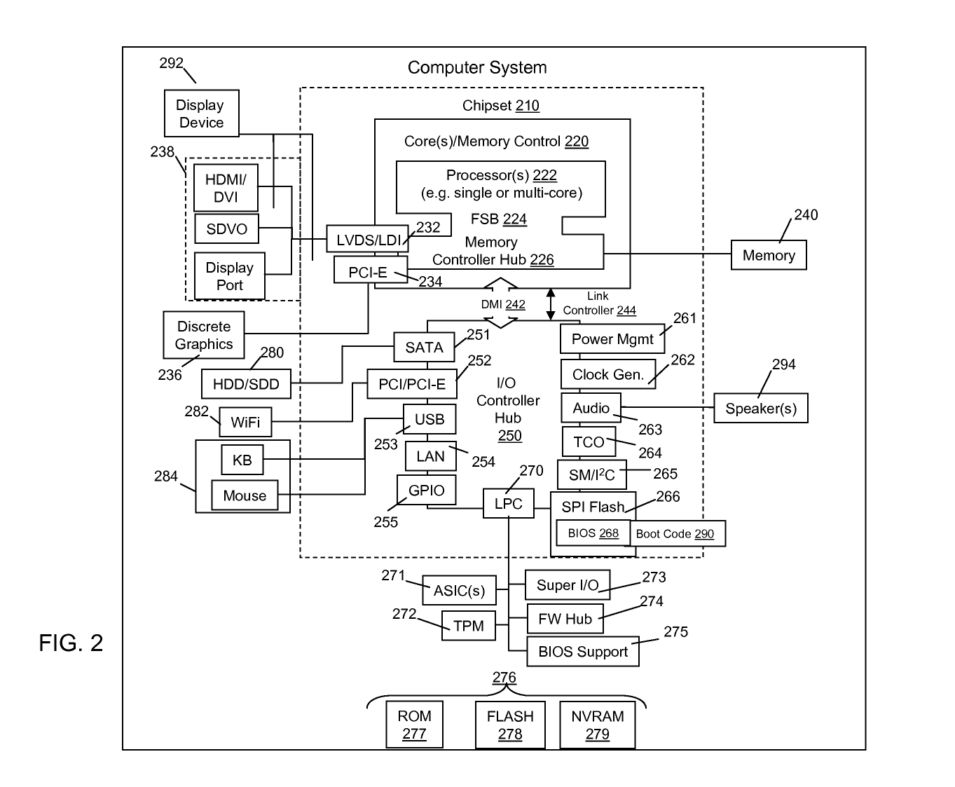

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that collect ephemeral data for use in contextual searching, as further described herein. Examples of the real-time ephemeral data that may be collected, and the sensors or other hardware devices or sources used in the collection, include but are not necessarily limited to environmental data (e.g., temperature, humidity, atmospheric pressure, wind speed, wind direction, etc., collected via, e.g., sensors such as thermometers, barometers, and/or access to applications containing such information derived from a third party), biometric data (e.g., human presence, human proximity, touch, facial recognition, eye tracking, gaze detection, etc., e.g., collected, e.g., via biometric devices such as a fingerprint reader, camera(s) or the like), light data (e.g., ambient, infrared, collected, e.g., via single or multi-dimensional camera(s)), sound data (e.g., acoustic record derived from microphone(s), etc), device orientation data (e.g., orientation data collected via a single or multi-dimensional compass, via a single or multi-dimensional inclinometer, etc.), device motion data (e.g., collected via a single or multi-dimensional accelerometer, via a single or multi-dimensional gyrometer, etc.), location data (e.g., collected via a global positioning satellite system, via a system collecting static, broadcast and/or dead reckoning data, etc.), scan data (e.g., triangulation data, barcode data, radio frequency identification data RFID, quick response (QR) code data, near field communication (NFC) data, etc., e.g., collected via components configured to collect the same, etc.), time data (e.g., real-time clock data, alarm data, etc.), hardware connection data (e.g., USB connection data, FIREWIRE cable connection data, high definition multimedia interface (HDMI) data, other port data, etc.), virtual connection data (e.g., web pages open, RSS feeds active, streams received, etc.), and device state data (e.g., open applications, power state, etc.).

While such ephemeral data may be collected, e.g., using a plurality of sensors, it may not be useful unless analyzed and converted into another form. For example, GPS data that is not processed (e.g., analyzed and associated with a nearby landmark) is not particularly useful. Moreover, such unprocessed data may not be in a suitable format for use by other applications.

Therefore, the expression of, or useful organization of, the ephemeral data can be maintained within a data store having organized data structures, e.g., contextual data tags, that contain contextual data derived from the sensed or otherwise acquired ephemeral data, e.g., association between GPS data and a known landmark.

Additionally, the sensed or otherwise derived ephemeral data may be associated with a reference to the user's object(s), e.g., files, documents, destinations, etc., such as being associated with a user object event. For example, GPS, audio data, etc., may be converted, e.g., analyzed and/or formatted and thereafter associated, e.g., in time and/or location, with a user object event such as object creation, object editing, object transferring, etc. Thus, by way of example, collected ephemeral GPS data may be converted into contextual data by associating it with a known landmark and thereafter associating it with an object event, e.g., editing a document. Similarly, collected ephemeral audio data may be converted to contextual data by extracting keywords from audio and associating the keywords with an object event, e.g., emailing the object to a device contact.

Furthermore, these references or associations, e.g., between contextual data and objects, may be maintained locally (i.e., on-device) and/or in remotely accessible storage, e.g., in the cloud. In addition to using file, process, application and hardware connection events as triggers for collecting the ephemeral data, the collection can also occur at regular intervals or otherwise according to a policy. This permits, for example, the best of the ephemeral data collected by co-located devices to be shared and associated with references to content/user objects on each of the user's devices. This also allows for a busy user device to use the ephemeral data collected by another user device, e.g., a user device that is less-busy and co-located. Accordingly, a user device may control (e.g., throttle) its own ephemeral data collection, e.g., until the particular user device is less busy or otherwise has appropriate processing and/or memory.

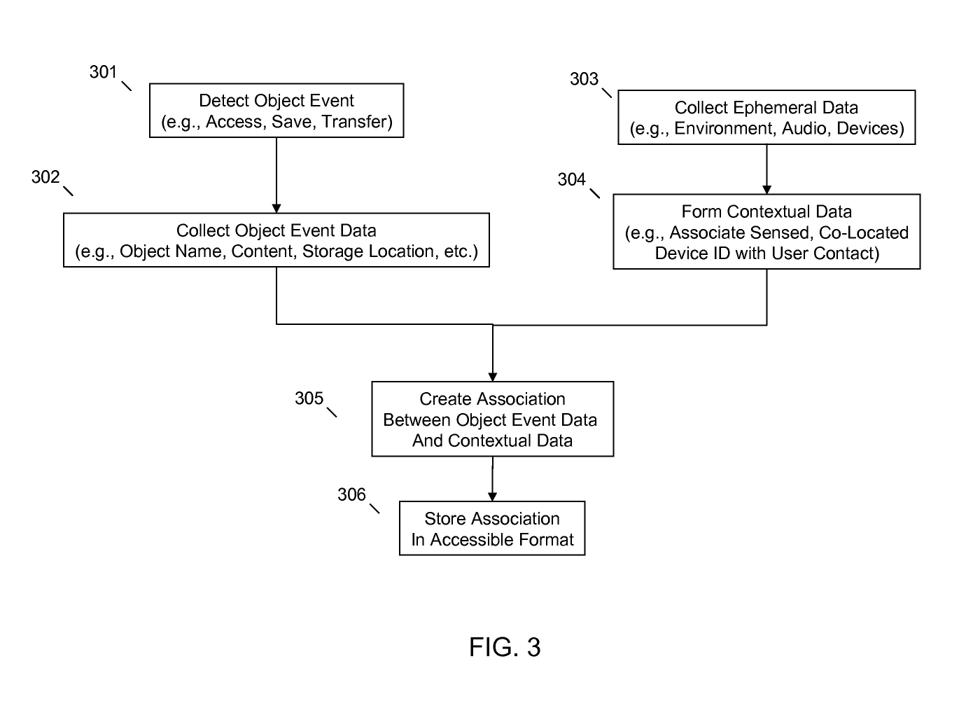

Referring to FIG. 3, an embodiment therefore detects an object event (e.g., accessing a user object, saving a user object, transferring a user object, etc.) at 301 and utilizes this as a trigger for collecting object event data at 302. The object event data collected at 302 may include but is not limited to a file name of the object, a storage location of the object, a type for the object (e.g., application type), as well as content of the object (e.g., key words).

Similarly, an embodiment may utilize the object event at 301 a trigger for collecting ephemeral data at 303, although the ephemeral data may be collected without use of such trigger, e.g., according to a timing policy. Nonetheless, the object event 301 may be utilized to associate the ephemeral data collected at 303 with the object which is the subject of the object event at 301. For example, sensor data collected from a plurality of sensors may be associated in time with the object for which the event takes place, e.g., at 301.

Given the availability of the ephemeral data collected at 303, an embodiment may convert the ephemeral data into a format usable by a searching application, e.g., convert the ephemeral data into contextual data terms. Ephemeral data is unstructured and there conventionally has been no easy way to find personal meaning or context in that ephemeral data.

Context may be comprised of ephemeral data gathered from a user device, e.g. sensors, hardware connections, etc. In addition, information gathered e.g. keywords, meta-data, etc. from user generated content/objects, may be stored as object event data by the user device(s). Facts gathered through current context are combined with user actions, calendar, email, etc., to form correlations or associations.

For example, as illustrated at 304, an embodiment may analyze the ephemeral data, e.g., GPS data, and convert it to contextual data. In this process, the ephemeral data may be converted to keywords or other searchable data. By way of example, raw ephemeral GPS coordinates may be converted into key words of a nearby location using map data. Similarly, a sensed, co-located user device, e.g., a friend or family member's smart phone detected via short range wireless or near field communication, may be associated with a device contact of the user device collecting the object event data. This information then may be collected, converted to a searchable form (e.g., text form of the location, text form of the device ID or contact name, etc.) and stored as contextual data at 304.

Having object event data and contextual data, an embodiment may thus associate the two at 305. In other words, at 305 an embodiment may create a reference or link between the contextual data, i.e., data derived from ephemeral data, and the object event data, i.e., data derived from with the object associated with the event. In this way, an embodiment may create a store of contextual data and object event data that is associated with a particular user object. This store may be formed at 306 for use in a variety of applications, e.g., answering user object search queries, as further described herein. This store may be compiled by various user devices and shared, e.g., via cloud account associations, and/or the contextual data and/or object event data may be stored locally on a single user device. Moreover, the store may be a distributed store, e.g., contextual data stored on one device, object event data stored another device, combinations of data stored on separate devices for sharing, or like arrangements.

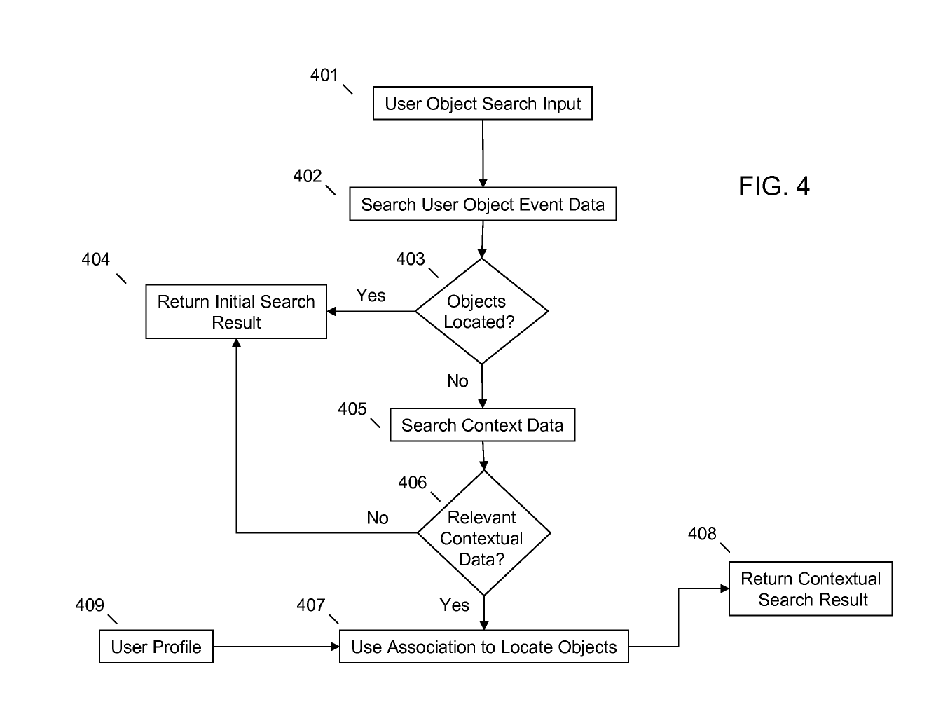

For a user application then, e.g., a user object searching application, the store of contextual data and object event data may be used to provide a more complete picture of the context surrounding various object events, including ephemeral data that is easy for the user to remember. By way of example, FIG. 4 illustrates an example of using contextual data in user object searching.

At 401 a user may enter user object search input, e.g., key words and/or time limits, etc., into a user object searching application. The user object searching application may search the user object event data according to the user object search input. For example, an embodiment may search the object event data for objects having creation times matching the input, search for object types matching the input, search for objects having keywords matching the input, etc. If objects are located, as determined at 403, an initial set of search results may be returned at 404. However, if objects are not located and/or an amount of objects are located such that the results may not be responsive (e.g., too many or too few objects), an embodiment may refine the searching using the contextual data available.

For example, if a user is searching for a document that the user knows was edited at a particular location and in a general time frame, searching of object event data may yield too many or too few results. For example, if the user correctly remembered the place and time, but not the title, keywords, etc., the object event data search might not locate the correct document or locate too many documents.

Accordingly, an embodiment may search the contextual data at 405, e.g., including location data associated with the document, such that relevant contextual data may be identified, as determined at 406. For example, an embodiment may find a contextual search term, e.g., a location associated with the user object search input, at 406. If so, an embodiment may use the association between this location term in the contextual data store, e.g., in time, with the user object, e.g., the document edited at the location, in order to return results at 408 that have been refined (e.g., re-ordered, ranked differently) or improved/modified using the contextual searching. If no relevant contextual data is found at 406, an embodiment may nonetheless return the initial search results based on object event data.

An embodiment may utilize the associations alone or may utilize the associations between contextual data and object event data to form correlations or associations there-between to provide an additional level of relevance or personal meaning.

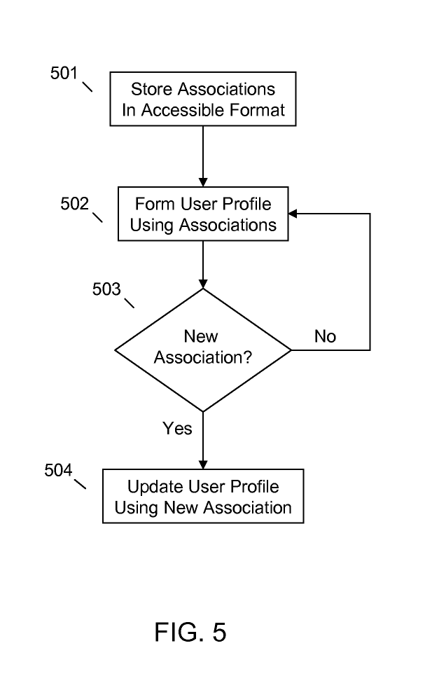

For example, referring to FIG. 5, an embodiment may form a long term stable user profile using the associations generated. An embodiment provides an inference engine that extracts semantic knowledge from the current context facts (e.g., context data, object event data, etc.) and correlations of those facts, and also discovers new knowledge based on the facts and knowledge previously inferred.

Knowledge may be discovered across devices (e.g., for one user or devices of many users) and therefore a user profile may be refined based on a rich history of user device interactions and/or based on group derived information. This information may in turn be utilized by various applications to add or infer additional context to the application processing, i.e., leveraging context information that is relevant for the user right now (or in the near future). The user profile for example may contain information regarding the user's preferences, interests, tastes, which may include a long-term stable description or characterization thereof which is updated accordingly, e.g., as new information such as new associations are available. The inference engine will adjust over time, e.g., adjusting the ranking of relevance of search results, and bias decisions, e.g., in response to user input commands, queries, etc., based on feedback from a group of users or from an individual user.

Accordingly, an embodiment may access stored associations between contextual data and object event data at 501, e.g., for a particular user or a group of users associated via a similarity metric such as a cloud account association. An embodiment forms a user profile using the associations to determine or characterize a user's behavior patterns in a long term stable way. For example, an embodiment may determine that a user repeatedly edits an object type (e.g., word processing document) at a particular location (e.g., work) based on the number of such associations that have been stored. A user's profile formed at 502 may include an indication of this correlation or pattern of behavior and be used, e.g., to refine a user's search results. As such, the user's profile may contain an organization of the associations between the various facts (e.g., object event data and contextual data) that may be used to refine the facts which are searched, refine results produce by searching the facts, improve inferences based on the facts, etc.

As described herein, an embodiment may utilize the user profile as a longer term or stable representation or characterization of a particular user's overall context with respect to a given object, object type, etc. Thus, if a new association is determined to be available at 503, e.g., via user activity or derived from a user of a group of associated users, an embodiment may add or take this new association into account, e.g., by updating the user's profile at 504. Otherwise, the user profile may remain unchanged.

Referring back to FIG. 4, an embodiment may access a user profile 409 as part of the process of using associations to locate objects at 407. The user profile may be used, e.g., to refine a search result for the user, such as refining the contextual data searched at 405 based on the associations frequently used by this particular user and/or adjusting the rankings of the results provided to the user at 409.

By way of example, an embodiment may utilize an initial search of contextual information at 405 to determine that a user is interested in certain objects created, accessed, modified, etc., at a certain location at 407. Additionally, an embodiment may bias or influence the context data searched at 405 and/or the ranking of such objects identified at 408 using information stored in the user profile 409. For example, an embodiment may rank objects known to be used by a user at a certain time (e.g., synchronized with the search input) to rank higher those types of objects in the search results. As may be appreciated then, the user profile provides an additional level of information that supplements and organizes the associations between the contextual data and the object event data to personalize the data collected and the user thereof.

While the associations stored are useful in and of themselves, an embodiment may access a user's profile to infer a user's preferences, interests, pattern of behavior, etc., to further improve the user's experience, e.g., the searching results produced at 408. This may include extracting common patterns and rules based on the behavior of the sum of all users or a relevant group of users or user devices, e.g., associated via a cloud account linkage. The resulting rules and patterns may be used to adjust the relevance of inferences for each individual user. This brings the wisdom of the crowd down to the experience of an individual user (i.e., a personal level).

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
collecting, using a user device, user object event data;
collecting, using a user device, contextual data related to the user object event data;
creating, using at least one processor, an association between the contextual data and the user object event data;
forming, using a processor having access to a stored group of associations between contextual data and user object event data, a user profile based on the group of associations; and
storing, in a memory, the user profile.

2. The method of claim 1, wherein the user profile includes a pattern of user behavior with respect to user objects.

3. The method of claim 1, wherein the stored group of associations between contextual data and user object event data comprises associations gathered from a group of associated users.

4. The method of claim 3, wherein the group of associated users comprise users having similar patterns of behavior.

5. The method of claim 3, wherein the group of associated users comprises users having a cloud account association.

6. The method of claim 1, wherein the user profile comprises a description of user behavior that is refined in response to obtaining one or more new associations.

7. The method of claim 6, wherein the one or more new associations are derived from user interaction with a user object.

8. The method of claim 6, wherein the one or more new associations are derived from a group of users.

9. The method of claim 8, wherein the group of users is identified using a similarity metric.

10. The method of claim 9, wherein the similarity metric is a cloud account association.

11. An information handling device, comprising:
a processor; and
a memory device that stores instructions executable by the processor to:
collect user object event data;
collect contextual data related to the user object event data;
create an association between the contextual data and the user object event data;
form, via access to a stored group of associations between contextual data and user object event data, a user profile based on the group of associations; and
store, in a memory, the user profile.

12. The information handling device of claim 11, wherein the user profile includes a pattern of user behavior with respect to user objects.

13. The information handling device of claim 11, wherein the stored group of associations between contextual data and user object event data comprises associations gathered from a group of associated users.

14. The information handling device of claim 13, wherein the group of associated users comprise users having similar patterns of behavior.

15. The information handling device of claim 13, wherein the group of associated users comprises users having a cloud account association.

16. The information handling device of claim 11, wherein the user profile comprises a description of user behavior that is refined in response to obtaining one or more new associations.

17. The information handling device of claim 16, wherein the one or more new associations are derived from user interaction with a user object.

18. The information handling device of claim 16, wherein the one or more new associations are derived from a group of users.

19. The information handling device of claim 18, wherein the group of users is identified using a similarity metric.

20. A product, comprising:
a storage device having code stored therewith, the code comprising:
code that collects, using a user device, user object event data;
code that collects, using a user device, contextual data related to the user object event data;
code that creates, using at least one processor, an association between the contextual data and the user object event data;
code that forms, using a processor having access to a stored group of associations between contextual data and user object event data, a user profile based on the group of associations; and
code that stores, in a memory, the user profile.
